(19) United States
(12) Patent Application Publication
(10) Pub. No.: US 2009/0282480 A1
(43) Pub. Date: Nov. 12, 2009

(54) Apparatus and Method for Monitoring Program Invariants to Identify Security Anomalies

(76) Inventors: Edward Lee, Cupertino, CA (US); Jacob West, San Francisco, CA (US); Matias Madou, Liehtervelde (BE); Brian Chess, Mountain View, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/463,334

(22) Filed: May 8, 2009

Related U.S. Application Data
(60) Provisional application No. 61/051,611, filed on May 8, 2008.

(51) Int. Cl. G06F 11/00; G06F 9/44

(52) U.S. Cl. 726/22; 717/128; 717/130

(57) ABSTRACT

A computer readable storage medium includes executable instructions to insert monitors at selected locations within a computer program. Training output from the monitors is recorded during a training phase of the computer program. Program invariants are derived from the training output. During a deployment phase of the computer program, deployment output from the monitors is compared to the program invariants to identify security anomalies.

### CROSS REFERENCE TO RELATED APPLICATIONS

This application claims priority to U.S. Provisional Patent Application 61/051,611 filed May 8, 2008, entitled “Apparatus and Method for Preventing Cross-Site Scripting by Observing Program Output”, the contents of which are incorporated herein by reference.

### FIELD OF THE INVENTION

This invention relates generally to software security. More particularly, this invention relates to the identification of program invariants and subsequent monitoring of program invariants to identify security anomalies.

### BACKGROUND OF THE INVENTION

A static analysis of source code can identify security vulnerabilities at the code level, which allows developers to fix the security vulnerabilities during development when they are less expensive to remediate. However, it is not always possible or desirable to modify source code. Vulnerabilities that are found late in a release cycle or in software that is already deployed are often left unfixed because the project is no longer under active development. Moreover, in the case of vendor-supplied and outsourced software, the owner of the project may not have access to code or the ability to correct vulnerabilities at the code level.

Web application firewalls (WAFs) attempt to address security vulnerabilities without requiring access or modification to source code. WAFs work by scanning incoming HTTP traffic for possible attacks and taking action to prevent them. There are two inherent limitations of this technique. First, there is no contextual information about the potential attack. Second, there is no visibility into other attack vectors, such as web services and back-end systems.

Regardless of when and where a solution attempts to identify attacks, the choice of how to identify attacks also plays a critical roll. At the highest level, the two primary approaches are known as black listing and white listing. Black listing, which is employed by most WAFs, involves enumerating bad behavior and using pattern matching to identify input that matches a list of probable attacks. This approach has the obvious limitation that it cannot prevent attacks that it has not been specifically instructed to identify and must be constantly updated to account for new attack techniques and variants. White listing, on the other hand, defines good behavior and disallows everything else. White listing has the distinct advantage that once the set of good behavior is defined, it can protect against attacks that are developed later.

It would be desirable to provide increased software security while overcoming constraints associated with prior art software security measures.

### SUMMARY OF THE INVENTION

A computer readable storage medium includes executable instructions to insert monitors at selected locations within a computer program. Training output from the monitors is recorded during a training phase of the computer program. Program invariants are derived from the training output. During a deployment phase of the computer program, deployment output from the monitors is compared to the program invariants to identify security anomalies.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

Like reference numerals refer to corresponding parts throughout the several views of the drawings.

### DETAILED DESCRIPTION OF THE INVENTION

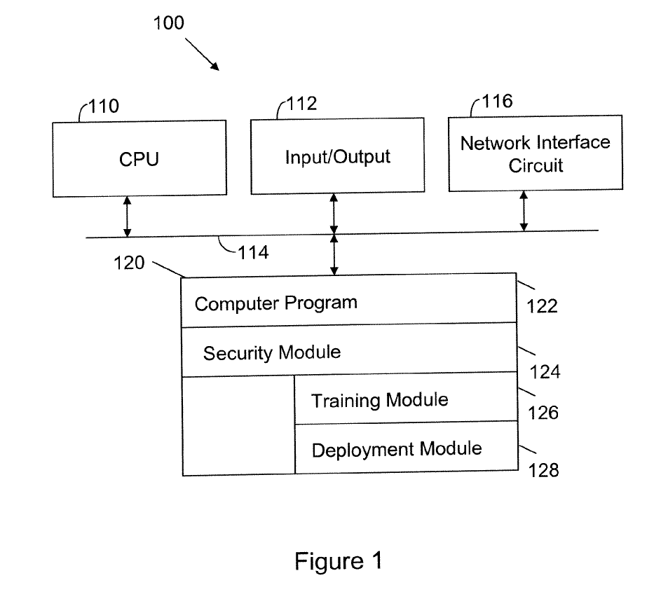

FIG. 1 illustrates a computer 100 configured in accordance with an embodiment of the invention. The computer 100 includes standard components, such as a central processing unit 110 and input/output devices 112 linked by a bus 114. The input/output devices may include a keyboard, mouse, display, printer and the like. Also connected to the bus 114 is a network interface circuit 116, which provides connectivity to a network (not shown).

A memory 120 is also connected to the bus 114. The memory 120 stores a computer program 122 that is processed in accordance with the invention. A security module 124 includes executable instructions to implement operations of the invention. In one embodiment, the security module 124 includes a training module 126 and a deployment module 128. The training module 126 includes executable instructions to instrument the computer program 122 with monitors. Output from the monitors is recorded by the training module 126 during a training phase. The training module 126 then derives program invariants from the training output. As used herein, an invariant expresses a condition that should exist during normal program operation, as observed during the training phase. An invariant is frequently deemed to be a property that always holds during program execution. However, in the event of a security breach, an attacker can break a so-called invariant.

The deployment module 128 receives input from the monitors during a deployment phase. The deployment phase output is compared to the program invariants to identify security anomalies.

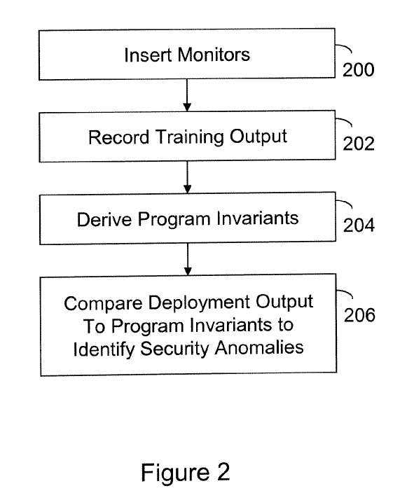

FIG. 2 illustrates processing operations associated with the security module 124. Initially, monitors are inserted into a computer program 200. A monitor is executable code used to generate an output indicative of program activity. The monitors may be automatically inserted into the program as part of a static analysis of the program.

The next operation of FIG. 2 is to record training output 202. Training output is recorded during a training phase of the program. The training phase refers to the normal operation of the program in the absence of hostile or disruptive activity (i.e., an attack-free operating mode).

Program invariants are then derived from the training output 204. The program invariants express the normative and otherwise expected behavior of the program.

The program then operates in a deployment phase. In the deployment phase, the program is subject to normal operation, including hostile or disruptive activity. Deployment phase monitor output is then compared to the program invariants. If program invariant violations are identified, security anomalies are expressed 206. A security response may also be invoked in response to a security anomaly. For example, the security response may be a thrown exception, a log entry, the display of a message or an alert to a system monitor.

The operations of the invention are more fully appreciated in connection with some specific examples. Consider the problem of Cross-site scripting (XSS). An XSS vulnerability permits attackers to include malicious code in the content a web site sends to a victim's browser. The malicious code is typically written in JavaScript, but it can also include HTML, Flash or any other type of code that will be interpreted by the browser. Attackers can exploit an XSS vulnerability in a number of different ways. They can steal authentication credentials, discover session identifiers, capture keyboard input, or redirect users to other attacker-controlled content.

The techniques of the invention defend web applications against XSS vulnerabilities at runtime using fine-grained dynamic output inspection. The primary difference between this approach and other automated techniques for mitigating the danger posed by XSS vulnerabilities at runtime is that the invention identifies dangerous values as they are written into the HTTP response rather than as they enter the program. This enables one to defend against attacks that cannot be witnessed at the HTTP request level, such as attacks that rely on data that are batch loaded into a database, arrive via web services or another non-HTTP entry point, or that appear in an encoded form when they enter the program. Inspecting output rather than input also enables one to implement more fine grained protections that better model real-world programming scenarios where certain dynamic behavior is acceptable in some situations but not in others. Finally, inspecting output as it is sent to the user means that not only does one identify attacks, but when a likely invariant is violated, one is able to report a true XSS vulnerability in the application because the malicious data have reached the user.

An XSS vulnerability can take one of three forms. Reflected XSS occurs when a vulnerable application accepts malicious code as part of an HTTP request and immediately includes it as part of the HTTP response. Persistent XSS occurs when a vulnerable application accepts malicious code, stores it, and later distributes it in response to a separate HTTP request. DOM-based XSS occurs when the malicious payload never reaches the server-it is only seen by the client. One embodiment of the invention defends web applications against reflected and persistent XSS attacks. As previously mentioned, there are two phases associated with the technique of the invention. In the first phase the target application is monitored during an attack-free training period with a finite duration and generate likely invariants on normal program behavior. The likely invariants are conditions that always hold during the training period. They are related to the types of output the program writes to the HTTP response. This phase can be carried out in conjunction with typical functional testing, which is intended to exercise a wide range of normal program behavior. If the program is well exercised during the training period, the invariants are likely to be ones that programmers believe will always hold. Once the set of likely invariants are identified, the application is deployed in a production environment. Program behavior that violates one or more likely invariants is subsequently identified.

Consider a simple blogging application. The blog contains a page that allows a user to submit the title and body of a new blog entry. An HTTP request to add a new entry is handled by the application server, which dispatches the request to the preview page named newblogjsp. The source for newblogjsp includes the following code:

```
<tr>
    <td class=newsCell><%= element.getTitle( ) %></td>
    <td class=newsCell><%= element.getBody( ) %></td>
</tr>
```

The URL portion of a typical HTTP request for this page might look like this:
http://example.com/preview.do?title=First&body=I+got+here+first.

The page generates the following HTML output as part of the HTTP response:

```
<tr>
    <td class=newsCell>First</td>
    <td class=newsCell>I got here first.</td>
</tr>
```

Another typical URI, might look like this:
http://example.com/preview.do?title=Me&body=My+photo%3A+%3Cimg+src%3D%22me.png%22%2F%3E

This will generate the following output:

```
<tr>
    <td class=newsCell>Me</td>
    <td class=newsCell>My photo: <img src=“me.png”/></td>
</tr>
```

This page is vulnerable to reflected XSS. Consider an attacker using the following URL:
http://example.com/preview?title=XSS&body=%3Cscript%3Ealert(‘vuln+to xss’)%3C%2Fscript%3E

The application generates the following response:

```
<tr>
    <td class=newsCell>XSS</td>
    <td class=newsCell><script>alert(‘vuln to xss’)</script></td>
</tr>
```

When a browser renders this HTML, it executes the JavaScript within the script tag.

As discussed above, an invariant is a property that always holds at a certain point in a program. Programmers sometimes check important invariants with assert statements or other forms of sanity checking logic. In order to determine likely invariants related to XSS, monitors are inserted into the program to record values included in content written to the HTTP response. An observation point is a method call that writes directly to the HTTP response. These are the locations used to characterize and monitor for XSS attacks.

The code from the newblog.jsp example could be translated into the following Java code:

20: out.write(“<td class=newsCell>“);
21: out.print(element.getTitle( ));
22: out.write(“</td>\t\r\n <td class=newsCell>“);
23: out.print(element.getBody( ));
24: out.write(“</td>“);

This code contains five observation points. Before the training period, monitors are inserted around these method calls. Preferably, a simple static analysis of the program is used to avoid monitoring method calls that can only write static content to the HTTP response because static content is immune to XSS vulnerabilities. For the code above, the relevant observation points are the calls to javax.servletjsp.JspWriter.print (Strings) on lines 21 and 23, because they are the only two methods that write dynamic content to the HTTP response.

An observation context is the state of the program when an observation point is invoked. The observation context is represented with the URL from the HTTP request and the current call stack. One can track the URL and call stack. In addition, it is possible to track other state information such as HTTP request parameters, HTTP request headers, or user roles. In general, the more dimensions there are to the observation context, the more fine-grained and robust the likely invariants and detection algorithm will be. By keeping track of contexts rather than just observation points, one can develop a different set of likely invariants for each context in which an observation point is used.

When an observation point executes, the associated context is examined. If a context has not been seen before, the argument to the observation point method call is used to establish a set of likely invariants. If the context already has likely invariants associated with it, it is determined if any of the likely invariants are violated by the current method argument. If a likely invariant is violated, the likely invariant is updated to make it consistent with the new behavior.

In one embodiment, likely invariants are of the form “The substring S always occurs X times at this observation point”. Substrings that consist of patterns that could be part of an XSS attack, such as <script, <img and javascript: are chosen. A collection of patterns may be derived from known XSS attacks. Counting the number of occurrences of each pattern allows a baseline of expected behavior. After the training period, any deviation from the expected behavior is considered a violation of the likely invariant.

Consider the application of this technique to the two normal requests for newblog jsp given earlier. Further consider the following values for this example:
<script
<img
javascript:

If the two requests are the extent of the training data, we will establish the following likely invariants:
line 21: The substring “<script” always occurs 0 times
line 21: The substring “<img” always occurs 0 times
line 21: The substring “javascript:” always occurs 0 times
line 23: The substring “<script” always occurs 0 times
line 23: The substring “javascript:” always occurs 0 times

The invariants for line 23 will allow an image tag but will not allow an attribute that contains the string javascript:. This preserves the intended functionality of the application while preventing a popular form of XSS attack. Other patterns are required in order to prevent other XSS varieties.

For ease of understanding, each invariant is labeled as corresponding to either line 21 or line 23, but the observation context also includes the URL and a call stack. This distinction has not been important in the examples given thus far, but it is critically important for establishing likely invariants when the same method call can be invoked from more than one place in the program. Consider the following modified version of the JSP code from newblog.jsp that uses the <logic:iterate> and <bean:write> tags to output the title and body values:

```
<logic:iterate id=“element” name=“profiles”
        scope=“request”
        type=“com.blog.postnew” >
        <tr>
        <td class=newsCell>
        <bean:write name=“element”
        property=“title”/></td>
        <td class=newsCell>
        <bean:write name=“element”
        property=“body”/></td>
        </tr>
        </logic:iterate>
```

This JSP code is transformed into the following Java code:

20: WriteTag jsp_beanwrite_title;
21: jsp_beanwrite_title.setName(“element”);
22: jsp_beanwrite_title.setProperty(“title”);
23: jsp_beanwrite_title.doStartTag( );
...
30: WriteTag jsp_beanwrite_body;
31: jsp_beanwrite_body.setName(“element”);
32: jsp_beanwrite_body.setProperty(“body”);
33: jsp_beanwrite_body.doStartTag( );

Notice that the code does not directly invoke the methods responsible for writing the dynamic output to the HTTP response. The call to javax.servlct.jsp. JspWriter.print ( ) is hidden within the implementation of do Start-Tag ( ), which is invoked from two distinct program points at line 23 and line 33. In order to establish different sets of likely invariants for the two calls, one takes the call stack into account.

When the program runs in a production environment, monitors are inserted at method calls used to write values to the HTTP response. Static analysis is preferably used to avoid monitoring method calls that only write static content. This time the monitors check observed behavior against the likely invariants derived during the training period. When a likely invariant is violated, any number of actions may be taken. For example, the attack may be logged or an exception may be raised. The program can include monitors to take an action appropriate for the program and execution environment in question.

When a monitor executes in a production environment, the likely invariants are matched to the current program state with the observation contexts witnessed during the training period. Comparing the entire call stack is costly in terms of overhead. To avoid doing so, a minimal set of call stack nodes can be called during the training period. The call stack nodes uniquely describe a group of contexts that share the same likely invariants. To compute this minimal set, group contexts that shared the same likely invariants. Then, for each call stack in each group, compare the last node before the observation point with the node in the corresponding position in call stacks for other groups. If the node is unique, then continue comparing the remaining contexts in the current group. If the node is not unique, then begin a breadth first search to find a node or set of nodes that are unique. If no single node position uniquely differentiates the call stacks in one group from all others, then expand the scope to two nodes and so on until this requirement is met.

Checking likely invariants independently is conceptually simple but computationally expensive. The checking at runtime may be accelerated by building regular expressions out of the likely invariants for each observation point; this reduces the overall number of comparisons performed. A set of special substrings can be combined into a single regular expression if the likely invariants associated with them all require zero occurrences of the substrings. Given a training period comprised of the normal request given in the example above, the invariants can be combined without loss of accuracy as follows:
line 21: The regular expression

“(<((img)|(script))|(javascript:)” matches 0 times
line 23: The regular expression

“(<script)|(javascript:)” matches 0 times

The accuracy of likely invariants depends on the extent of normal program behavior exercised during the training period; normal program behavior that violates a likely invariant but is not witnessed during the training period will result in false positives when the invariant is later enforced. Conversely, the presence of attack data or normal program behavior that cannot be distinguished from attack data introduces false negatives because a likely invariant cannot be derived.

A given training period is unlikely to exercise all possible permutations of normal program behavior. However, a training period that is sufficiently broad to avoid false positives is achievable in practice. With respect to false negatives, in a controlled environment it should be possible to ensure that no attack data are included in the training period.

Unlike network based input filtering technology, this technique only needs to account for variations of XSS patterns that will be interpreted directly by browsers, rather than accounting for packet fragmentation attacks or server specific encoding and decoding. The variations that should be considered include: opening tags, closing tags, null characters, JavaScript event handlers, variations of javascript:, CSS (Cascading Style Sheets) import and CSS expression directives. When a new attack pattern is discovered, the system should be updated. One implementation monitors observation points that take string arguments. Methods that output characters or byte arrays may also by analyzed.

Automatic discovery of XSS is often performed at runtime by penetration testing tools. However, these tools are dependent on their ability to effectively crawl the application under test and can have difficulty scanning applications where navigational links and content are controlled dynamically with JavaScript. Static source code analysis tools are effective at discovering XSS vulnerabilities and have the advantage of providing full code coverage, but also have difficulty with dynamically generated content. Therefore, a combination of runtime and static analysis techniques is an effective solution for identifying XSS vulnerabilities.

The invariants are akin to a blacklist: they specify particular patterns that should not appear in the output when the program runs. White list invariants may also be used. A white list invariant may be of the form “The argument string always matches the regular expression R”. The white list approach has several advantages. First, white listing is generally known to be better for protection than blacklisting. Second, it might reduce the overhead. It takes much longer for the engine to declare that a regular expression did not match an input string (blacklisting) than it does to find a successful match (white listing).

It is sensible to choose regular expressions that match textual representations of common data types that are inert when rendered by a web browser. For example, there should be regular expressions for integers, email addresses, and phone numbers. A white list mechanism is particularly useful in accurately protecting against XSS vulnerabilities where an application includes attacker-controlled input in existing JavaScript content because none of the usual malicious strings are necessary to cause the code to be executed in this case.

The default java.util.regex with basic optimizations may be used for pattern matching. Single pattern matching algorithms and the multi-pattern matching algorithms may also be used.

In order to make this technique more resilient to evolving program behavior and incomplete training data, it is desirable to derive and update invariants in production. This is challenging because it is difficult to guarantee that the program behavior will be free from attacks. In addition, the performance constraints of a production system are very different from one in a testing environment. Nevertheless, targeting specific behavioral idioms addresses these problems.

The task of modeling normal program behavior is simplified by accurately differentiating user input from application-controlled values in production systems. To this end, dynamic taint propagation techniques may be used. With these capabilities, the techniques of the invention can be used where the data in question are user controlled. This avoids unnecessary effort on data that are under the application's control.

Another security anomaly that may be identified by the invention is a SQL injection attack. SQL injection is a code injection technique that exploits a security vulnerability occurring in the database layer of an application. The vulnerability is present when user input is either incorrectly filtered for string literal escape characters embedded in SQL statements or user input is not strongly typed and thereby unexpectedly executed. It is an instance of a more general class of vulnerabilities that can occur whenever one programming or scripting language is embedded inside another.

The security module 124 may be configured to scan the program 122 for program points that execute SQL queries against a database. For example, the following line of Java code corresponds to a bytecode statement that executes a SQL query and would be identified during this step:
statement.executeQuery(query);

Monitors are inserted around such program points. The monitor records every executed query. For example, the monitor may be of the following form:

Record(query)
statement.executeQuery(query);

After this step, the program's behavior will remain the same as the uninstrumented program, but the added code records training information. Next, the user deploys the instrumented program, with its newly added statements for recording training information, and interacts with the program in an effort to enumerate expected or normal user behavior. Ideally, this interaction will not contain attack data. For example, the added code might record a series of SQL queries similar to the following:

SELECT * FROM database WHERE parameter = ‘data_1’
SELECT * FROM database WHERE parameter = ‘data_2’
SELECT * FROM database WHERE parameter = ‘data_3’
...

Based on the recorded behavior, normal behavior for each program point is defined. In this example, the parameter value is changing, but the remainder of the query is unchanged. The system points this out and constructs a query that allows a changing parameter value, but defines the unchanging portions of the query as normal. The derived normal behavior for the sample data may be:

SELECT*FROM database WHERE parameter=?

The code is once again modified to remove the recording code previously inserted and to add additional logic around program points that require queries executed at a particular program point to conform with the normal behavior. When a query matches normal behavior, the query is allowed to execute against the database. When it does not match, the request is seen as an attack and will be blocked. The following pseudo-code shows what this additional logic might look like at the code level:

```
Check(query matches “SELECT * FROM database WHERE
parameter = ?”)
If valid
then
    statement.executeQuery(query);
else
    Block! We’ve found an attack.
```

In one embodiment, program behavior is monitored at the API-level by inserting code to inspect the execution of any potentially vulnerable SQL queries as they are executed against the database. At this point, the SQL query has been constructed from strings that are controlled by the application (either hardcoded or read from a trusted resource) and possibly strings that originate from the user (all that's visible at the network layer). Independent from the origin of the strings, this technique captures the completed SQL query.

The particular points in the program where SQL queries are monitored are called the sinks. Such program points are used as a point of reference to differentiate between different SQL queries. For example, all calls to the Statement.executeQuery( ) method from the java.sql package will be instrumented and the SQL queries executed by this API will be assigned to the corresponding sink.

In one embodiment, the API's instrumented to derive training information are:
java.sql.Statement

addBatch

execute

executeQuery

executeUpdate
java.sql.Connection

prepareCall

prepareStatement

Different paths through the program can construct different SQL queries. However, it is possible that these different queries can be executed by one single sink in the application. For instance, a wrapper function can be used to execute all SQL queries against the database. When this happens, the training information for that one program point contains all the executed SQL queries (or training information) and it is difficult to derive an accurate characterization of normal behavior.

To overcome this problem, context is used. In the ideal scenario, the context is a description of how the SQL query was constructed in the program. A suitable context can be derived from the running program. The SQL query processing of the invention is more fully appreciated in connection with the following examples.

One can subdivide the construction of SQL queries that are vulnerable to SQL injection into the following three categories.

### Category 1

```
if(first != null){
    String query = “SELECT * FROM tab WHERE
    first = ‘” + first + “’”;
    rs = conn.createStatement( ).executeQuery(query); //Simple.java:69
}
if(last != null){
    String query = “SELECT * FROM tab WHERE last = ‘” + last + “’”;
    rs = conn.createStatement( ).executeQuery(query); //Simple.java:73
}
```

### Characterizations:

No conditional statements in the construction of each query.
The execution of each query is done by a direct call to the execute-SQL API.

### Category 2

```
if(first != null){
    String query = “SELECT * FROM tab WHERE ”;
    if(!first.equals(“”)){
        query += “first = ‘” + first + “’”;
        rs=executeQueryWrapper(conn, query); //Wrappers.java:83
    }
}
if(last != null){
    String query = “SELECT * FROM tab WHERE ”;
    if(!last.equals(“”)){
            query += “last = ‘” + last + “’”;
            rs=executeQueryWrapper(conn, query); //Wrappers.java:90
    }
}
  ...
ResultSet executeQueryWrapper(Connection conn, String query){
    return
    conn.createStatement( ).executeQuery(query);//Wrappers.java:113
}
```

### Deviance:

The execution of each query is done by a wrapper function which calls the execute-SQL API.

### Category 3

```
String query = “SELECT * FROM tab WHERE ”;
if(!first.equals(“”)) //Complex:75
{
    query += “first = ‘” + first + “’”;
    if(!last.equals(“”))//Complex:78
        query += “ and ”;
}
if(!last.equals(“”)) //Complex:81
    query += “last = ‘” + last + “’”;
if(!first.equals(“”) && !last.equals(“”))//Complex:83
    ResultSet rs =
            conn.createStatement( ).executeQuery(query);
            //Complex.java:84
```

### Deviance:

Conditional statements in the construction of each query.

During execution, calls to executeQuery( ) in these categories will execute different queries. Below there are examples of the monitored SQL queries executed by the executeQuery API during an attack free training session.

### Category 1

Simple.java:69:

SELECT * FROM tab WHERE first = ‘Stan’
SELECT * FROM tab WHERE first = ‘Kyle’
SELECT * FROM tab WHERE first = ‘Randy’
SELECT * FROM tab WHERE first = ‘Erik’
SELECT * FROM tab WHERE first = ‘Kenny’
...

Simple.java:73:

SELECT * FROM tab WHERE last = ‘Marsh’
SELECT * FROM tab WHERE last = ‘Broflovski’
SELECT * FROM tab WHERE last = ‘Cartman’
SELECT * FROM tab WHERE last = ‘McCormick’
...

### Category 2

Wrappers: 113:

SELECT * FROM tab WHERE first = ‘Stan’
SELECT * FROM tab WHERE last = ‘Marsh’
SELECT * FROM tab WHERE first = ‘Kyle’
SELECT * FROM tab WHERE last = ‘Broflovski’
SELECT * FROM tab WHERE first = ‘Randy’
SELECT * FROM tab WHERE first = ‘Erik’
SELECT * FROM tab WHERE last = ‘Cartman’
SELECT * FROM tab WHERE first = ‘Kenny’
SELECT * FROM tab WHERE last = ‘McCormick’
...

### Category 3

Complex:84:

SELECT * FROM tab WHERE first = ‘Stan’
SELECT * FROM tab WHERE last = ‘Marsh’
SELECT * FROM tab WHERE first = ‘Stan’ and last = ‘Marsh’
SELECT * FROM tab WHERE first = ‘Kyle’
SELECT * FROM tab WHERE last = ‘Broflovski’
SELECT * FROM tab WHERE first = ‘Kyle’ and last = ‘Broflovski’
SELECT * FROM tab WHERE first = ‘Randy’
SELECT * FROM tab WHERE last = ‘Marsh’
SELECT * FROM tab WHERE first = ‘Randy’ and last = ‘Marsh’
SELECT * FROM tab WHERE first = ‘Erik’
SELECT * FROM tab WHERE last = ‘Cartman’
SELECT * FROM tab WHERE first = ‘Erik’ and last = ‘Cartman’
...

The normal program behavior is derived from this training material. Describing the normal program behavior with regards to SQL queries is done by normalizing the SQL query. The normalized SQL query should match all the SQL queries that are seen during the training period and it should not match attack queries.

Normalizing the queries can be done in multiple ways. For instance, it is possible to parse the SQL query and use the parse tree as the normal behavior or it is possible to count the number of data and control objects in the SQL query. Deciding which normalized form to use may be based on factors like the possibility to craft an attack that would be accepted by the normal behavior or the trade-off between security and overhead.

In one embodiment, queries are normalized by replacing everything between quotes with a generic tag, like:

<text_data>

and replacing the numbers by a generic tag like:

<number_data>

A parse tree may also be used for normalization.

The invariant that can be derived after an attack free training phase is:

### Category 1: Context

Simple.java:69:

SELECT*FROM tab WHERE first=<text_data>
Simple java:73:

SELECT*FROM tab WHERE last=<text_data>

### Category 2: Context

Wrappers:113:

SELECT * FROM tab WHERE first = <text_data>
SELECT * FROM tab WHERE last = <text_data>

### Category 3: Context

Complex:84:

SELECT * FROM tab WHERE first = <text_data>
SELECT * FROM tab WHERE last = <text_data>
SELECT * FROM tab WHERE
first = <text_data> and last = <text_data>

The normalized queries derived from the training data are installed at the appropriate sink. Afterwards, each request that comes in is matched against the normalized query. For instance, the execution of

SELECT*FROM tab WHERE first=‘Matias’

at Simple.java:69 (Category 1) is normalized to

SELECT*FROM tab WHERE first=<text_data>

This normalized query is matched against the installed normalized query, which is:
Simple.java:69:

SELECT*FROM tab WHERE first=<text_data>

The two normalized queries match. Thus, this request is processed.

When the following request is monitored at Simple.java:69 (Category 1):

SELECT*FROM tab WHERE first=‘Matias’ or 1=1

the derived normalized query will be:

SELECT*FROM tab WHERE first=<text_data> or <number_data>−<number_data>

This derived normalized query does not match the installed normalized query so it is deemed an attack and an action can be taken to stop this attack from progressing. The action should prevent the execution of the query against the database.

For some sinks, it is still possible to craft an attack vector that matches a normalized query. For example, in Category 3 multiple normalized queries are installed for a single sink. By injecting the right attack vector, it is possible to go from one normalized query to another.

For example, by setting the first name to

Stan’ and last=‘Marsh

and leaving the last name empty, the created query will be

SELECT*FROM tab WHERE first=‘Stan’ and last=‘Marsh’

The normalized query will no longer be

SELECT*FROM tab WHERE first=<text_data>

but

SELECT*FROM tab WHERE first=<text_data> and last=<text_data>

When multiple normalized queries are installed for a single sink, there is additional information needed to distinguish between these normalized queries. A context is needed that makes sure that the correct normalized query is taken to match against. Possible contexts are the stack trace at the sink program point or a description of the conditional statements on the path to the sink.

Choosing the right context is a trade off between security and overhead. Taking a complicated context into consideration might produce a significant overhead and is not always necessary. For example, additional context to the sink as context for Category 1 is overkill. Taking a simple context into consideration might let attacks go through. For example, taking the sink as context in Category 3 will let attacks go through.

When there is a 1-1 relation between a context and a normalized query that is executed it is no longer possible to transform one normalized query into another one by using an attack vector. Consider the following:

Category 1: Context=sink
Simple.java:69:

SELECT*FROM tab WHERE first=<text_data>
Simple.java:73:

SELECT*FROM tab WHERE last=<text_data>

### Category 2: Context=Stack Trace

Wrappers:83-Wrappers:113:

SELECT*FROM tab WHERE first=<text_data>
Wrappers:90-Wrappers: 113:

SELECT*FROM tab WHERE last=<text_data>

Category 3: Context=Path taken

```
if(Complex:75)^{T}-if(Complex:78)^{F}-if(Complex:81)^{F}-
if(Complex:83)^{T}-Complex:84
        SELECT * FROM tab WHERE first = <text_data>
if(Complex:75)^{F}-if(Complex:78)^{F}-
if(Complex:81)^{F}-if(Complex:83)^{T}-Complex:84
        SELECT * FROM tab WHERE last = <text_data>
if(Complex:75)^{F}-if(Complex:81)^{T}-
if(Complex:83)^{T}-Complex:84
        SELECT * FROM tab WHERE
        first = <text_data> and last = <text_data>
```

The phase of each sink in the application can be independent from other sinks. Therefore, the application itself does not have to be entirely in the training phase or in the protection phase. Part of the application can be in protection mode while other parts are training.

Full coverage of the application means that each allowed path in the program is executed with all the possible data. Of course, it is nearly impossible to build such a training set. This raises the question of when to switch from training mode to protection mode.

For instance, when only one normalized query

SELECT*FROM tab WHERE first=<text_data>

is found after training Category 3 code, then the training data does not cover all possible executions. The training data misses normalized queries. When the decision is made to go into protection mode, queries that are normalized to:

SELECT * FROM tab WHERE last = <text_data>
SELECT * FROM tab WHERE first = <text_data> and
last = <text_data>

are blocked.

To overcome this problem, one may train the application for an extensive time period. Alternately, one may switch from training to protection mode after an extensive number of queries are executed at a particular sink.

It is possible to have sinks in the application in protection mode, and other sinks in training mode. If conditions are met for certain sinks, they can be switched to protection mode while other sinks remain in training mode.

Ideally, the training is attack free. However, in most cases this is not feasible or is just too expensive. There are two possibilities to eliminate the normalized queries derived from training data: (a) by a human or (b) by an automated process based on a set of parameters.

In the first case, a person close to the SQL code can in most cases easily determine if a normalized query is allowed. In some cases, it is obvious that an attack happened. For instance, a normalized query for Category 1 derived from attack data that is obvious to filter out is:

SELECT*FROM tab WHERE first=<text_data> or <number_data>=<number_data>

An automated process may also be used. An automated process to filter out normalized queries can be based on the following. When the application is up, most of the requests will be requests from regular users who want to retrieve information in a correct way. Only minimal attack requests will be experienced. This reasoning is not always true, but this seems to be the case in the field. Accordingly, the mechanism can discard normalized queries that appear only a fraction of the time. This heuristic is very hard to get right and depends in most cases on the specifications of the application itself.

Those skilled in the art will appreciate various aspects of the invention. For example, while it is known to derive invariants for various purposes, the derivation and use of invariants in security operations is believed to be a new application of invariants. It should also be appreciated that the internal code of a program is being monitored. This stands in contrast to other security monitoring operations, which commonly focus on network packets or operating system calls. It should also be appreciated that the invention does not operate to determine if a program is a virus or a piece of malware. Instead, the invention operates in connection with a legitimate program that is being attacked to operate in an illegitimate manner.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
insert monitors at selected locations within a computer program;
record training output from the monitors during a training phase of the computer program;
derive program invariants from the training output; and
compare, during a deployment phase of the computer program, deployment output from the monitors to the program invariants to identify security anomalies.

2. The computer readable storage medium of claim 1 wherein the security anomalies include illegitimate attacks upon a computer program considered to be legitimate.

3. The computer readable storage medium of claim 1 wherein the executable instructions to insert include executable instructions to insert monitors at computer program write locations.

4. The computer readable storage medium of claim 3 wherein the executable instructions to insert include executable instructions to insert monitors at computer program HTTP write locations to prevent cross-site scripting.

5. The computer readable storage medium of claim 1 wherein the executable instructions to insert include executable instructions to insert monitors at computer program query execution locations.

6. The computer readable storage medium of claim 5 wherein the executable instructions to insert include executable instructions to insert monitors at computer program SQL query execution locations to prevent SQL injection attacks.

7. The computer readable storage medium of claim 1 wherein the program invariants have associated program context.

8. The computer readable storage medium of claim 1 further comprising executable instructions to supply a security response.

9. The computer readable storage medium of claim 8 wherein the security response is an exception.

10. The computer readable storage medium of claim 8 wherein the security response is a log entry.

11. The computer readable storage medium of claim 8 wherein the security response is a displayed message.

12. The computer readable storage medium of claim 8 wherein the security response is an alert to a system monitor.
